(19) United States
(12) Patent Application Publication
(10) Pub. No.: US 2024/0126420 A1
(43) Pub. Date: Apr. 18, 2024

(54) SYSTEMS AND METHODS FOR PREVENTING UNWANTED INTERACTIONS IN A LIVE STREAM EVENT

(71) Applicant: WHATNOT INC., Marina Del Rey, CA (US)

(72) Inventors: Avery Lucas Segal, Naples, FL (US); Ariel Federico Alvarez, Barcelona (ES); Natalie Muenster, Edwards, CO (US)

(21) Appl. No.: 17/966,494

(22) Filed: Oct. 14, 2022

(51) Int. Cl. G06F 3/04847; G06Q 30/08

(52) U.S. Cl. CPC G06F 3/04847; G06Q 30/08

(57) ABSTRACT

A mobile software application implementing “live events,” via which a host of the event may sequentially offer one, two, three, four or more items to a plurality of guests in the event (e.g., via auction, via direct purchase, or via a giveaway). The host's device may obtain and transmit a real-time video stream, which is in turn provided to each guest's device in conjunction with real-time information about the item(s) being offered. Particular techniques protect a guest in a live event from unintentionally performing certain sensitive actions associated with the live event (e.g., placing bids or performing purchases). In particular, user interface elements may require the guest to perform a particular set of user interface interactions to perform the sensitive actions.

### TECHNICAL FIELD

The present disclosure generally relates to mobile computing device communications, and more specifically, to systems and methods for preventing unwanted interactions on the part of a user participating in a live stream event.

### BACKGROUND OF THE DISCLOSURE

Technological improvements to mobile computing devices, such as smartphones, smart tablets, and the like, have offered opportunities to make various interactive electronic services available via mobile computing devices, where previously such services might have only been available at most via desktop and/or laptop computers. Such electronic services have included, for example, auctions of consumer goods, including collectible items such as trading cards, toys, figurines, comic books, video games etc.

In particular, an existing platform available on mobile computing devices enables a seller or “host” user to offer one, two, three or more items consecutively (e.g., for sale in the form of an auction or offer for direct purchase, or in the form of a giveaway) via a live event. In the live event, the host's device records a real-time video/audio stream, which prospective bidders or “guests” view at their own devices in conjunction with a graphical user interface (GUI) that enables the guests to send and receive communications regarding the offers (e.g., auction bids, comments, updates to items, etc.) substantially in real-time. The host can use their transmitted video stream to, for example, visually feature a currently offered item and/or other items in the host's collection. At least these aspects of live events provide substantial benefits over conventional systems for online auctions and other online commerce systems, for example by enabling hosts and guests to send and receive updated information substantially in real-time without the devices having to reload or refresh the GUI by which the devices participate in the live event, thus providing uninterrupted, social access to the live event. Further description, including system implementation details for live events, is provided in U.S. Pat. No. 11,196,577, filed Apr. 22, 2021, which is hereby incorporated by reference herein in its entirety.

### SUMMARY

Although the live events described in the foregoing background provide technical and practical advantages, the present description identifies still further improvements that may be made, particularly in preventing guests from unintentionally performing certain sensitive actions in the live event (e.g., unintentionally placing a bid in an auction, or performing a direct purchase of an items).

In embodiments, one or more interactive graphical user interface (GUI) elements may be provided in one or more interactive GUIs displayed at a client computing device of a guest user during an offering of an item in a live event (e.g., via a smartphone touchscreen). The one or more interactive user interface elements may require a particular ordered set of GUI interactions from the guest user to perform a sensitive action pertaining to the offering of the item (e.g., attempting to acquire the item by placing a bid in an auction or by attempting a direct purchase in an offer for direct purchase). The ordered set of GUI interactions may, for example, involve a touch, drag, and release of a slider element in the GUI. Guarding the particularly sensitive action behind the particular set of GUI interactions protects the guest against unintentionally performing the sensitive action during the offering of the item (e.g., unintentionally bidding on an item or unintentionally performing a direct purchase of an item in which guest is not actually interested).

In some embodiments, the ordered set of GUI interactions is the only provided mechanism for performing the sensitive action in the live event via the displayed GUI(s). In other embodiments, an alternate mechanism(s) may be provided to perform the sensitive action by way of the same (and/or other) GUIs associated with the live event, but any alternate mechanism(s) may require still other navigation of interfaces, interactions, etc. from the guest user, such that the guest user remains protected against unintentionally performing the sensitive action in the live event.

In embodiments, a computer-implemented method is provided. The computer-implemented method may include (1) displaying, via a display unit of a client computing device, one or more interactive GUIs displaying information associated with a current item offered in a live event, the one or more GUIs comprising one or more interactive GUI elements usable at the client computing device to submit an attempt to acquire the current item, wherein submitting the attempt to acquire the current item using the one or more interactive GUI elements requires performing a particular ordered plurality of GUI interactions with the one or more interactive GUI elements, (2) receiving, via the one or more interactive GUIs via input from a user associated with the client computing device, the ordered plurality of GUI interactions with the one or more interactive GUI elements, and/or (3) responsive to receiving the ordered plurality of GUI interactions, transmitting, to one or more servers via one or more processors, communications indicative of the attempt to acquire the current item. The computer-implemented method may include additional, fewer, and/or alternate actions, in various embodiments.

In embodiments, one or more non-transitory computer readable media are provided. The one or more non-transitory computer readable media may store non-transitory computer executable instructions that, when executed via one or more processors of a client computing device, cause the client computing device to (1) display, via a display unit of the client computing device, one or more interactive GUIs displaying information associated with a current item offered in a live event, the one or more interactive GUIs comprising one or more interactive GUI elements usable at the client computing device to submit an attempt to acquire the current item, wherein submitting the attempt to acquire the current item using the one or more interactive GUI elements requires performing a particular ordered plurality of GUI interactions with the one or more interactive GUI elements, (2) receive, via the one or more interactive GUIs via input from a user associated with the client computing device, the ordered plurality of GUI interactions with the one or more interactive GUI elements, and/or (3) responsive to receiving the ordered plurality of GUI interactions, transmit, to one or more servers, communications indicative of the attempt to acquire the current item. The one or more non-transitory computer readable media may include additional, fewer, and/or alternate instructions, in various embodiments.

In still other embodiments, a client computing device is provided. The client computing device may include one or more processors, a display unit and one or more memories storing non-transitory computer executable instructions. The instructions, when executed via the one or more processors, may cause the client computing device to (1) display, via the display unit, one or more interactive GUIs displaying information associated with a current item offered in a live event, the one or more interactive GUIs comprising one or more interactive GUI elements usable at the client computing device to submit an attempt to acquire the current item, wherein submitting the attempt to acquire the current item using the one or more interactive GUI elements requires performing a particular ordered plurality of GUI interactions with the one or more interactive GUI elements, (2) receive, via the one or more interactive GUIs via input from a user associated with the client computing device, the ordered plurality of GUI interactions with the one or more interactive GUI elements, and/or (3) responsive to receiving the ordered plurality of GUI interactions, transmit, to one or more servers, communications indicative of the attempt to acquire the current item. The client computing device may be configured to perform additional, fewer, and/or alternate actions, in various embodiments.

### BRIEF DESCRIPTION OF THE FIGURES

FIG. 1 is a block diagram of an example computing environment, in accordance with some embodiments of the present description;

FIG. 2 is a signal diagram detailing example actions associated with using one or more interactive user interface elements to perform a bid or purchase in a live event, in accordance with some embodiments;

FIG. 3A is an example representation of GUI associated with an offering of an item executing on a mobile computing device, in accordance with some embodiments;

FIG. 3B is an example representation of user interaction with GUI elements from the GUI of FIG. 3A, in accordance with some embodiments;

FIG. 3C is another example representation of user interaction with the GUI elements from the GUI of FIG. 3A, in accordance with some embodiments;

FIG. 3D is still another example representation of user interaction with the GUI elements from the GUI of FIG. 3A, in accordance with some embodiments;

FIG. 3E is an example representation of a failed user interaction with the GUI elements from the GUI of FIG. 3A, in accordance with some embodiments;

FIG. 3F is an example representation of an updated GUI associated with an offering of an item, in accordance with some embodiments;

FIG. 3G is an example representation of an alternate GUI associated with an offering of an item executing on a mobile computing device, in accordance with some embodiments;

FIG. 3H is an example representation of user interaction with a GUI element from the GUI of FIG. 3G, in accordance with some embodiments;

FIG. 3I is another example representation of user interaction with a GUI element from the GUI of FIG. 3G, in accordance with some embodiments;

FIG. 3J is an example representation of a user interaction bounding area associated with the elements of the GUIs of FIGS. 3A-3F, in accordance with some embodiments;

FIG. 3K is an example representation of a user interaction bounding area associated with elements of the GUIs of FIGS. 3G-3I, in accordance with some embodiments;

FIG. 4 is a block diagram of an example mobile computing device and server, in accordance with some embodiments; and

FIG. 5 is a flow diagram of an example method implemented via a client computing device, in accordance with some embodiments.

### DETAILED DESCRIPTION

Embodiments of the present description relate to computing systems and methods that, broadly speaking, utilize a software application implemented at mobile electronic computing devices and/or other electronic computing devices, the application allowing “host” users to host a live event to offer (e.g., for auction, for direct purchase, or as a giveaway) various items, such as trading cards, card packs, toys, figurines, comic books, manga, vintage video games, clothing, tickets, an entry for a contest or giveaway, an opportunity to acquire an item, etc. Embodiments of the present description further relate to particular techniques for preventing guests from unintentionally performing certain sensitive actions (e.g., placing a bid in an auction, or performing a direct purchase) in the live event.

A live event, as described in the foregoing background section of the present disclosure enables a host (sometimes referred to herein as a “seller”) to offer one, two, three, four or more items to prospective buyers (“guests” in the event) in conjunction with transmitting a real-time video stream from the host's computing device (e.g., a smartphone). The real-time video stream is ultimately displayed at each of the guests' devices (e.g., smartphones of each guest) in conjunction with real-time information associated with the one, two, three, four or more items (and more particularly, the item currently being offered for auction, direct purchase, etc.). Accordingly, a video-stream-enabled live event will be referred to herein as a “live stream event.” However, video and/or audio streaming may be omitted from the live event in some embodiments. For example, in some embodiments, the live event may be presented to users in conjunction with a pre-recorded video, one or more static images, and/or other audio and/or video media content presented at host and/or guest devices.

An extensive description of the implementation of live stream events, with respect to various example graphical user interfaces (GUIs) for host and guest devices, is provided in U.S. Pat. No. 11,196,577, filed Apr. 22, 2021. Generally speaking, though, a live stream event may make various interactive GUIs available to guest devices, via which any guest may, for example, competitively bid on or directly purchase a currently offered item, post comments for viewing by other guests and/or the host in the event, explore other items available from the host, and/or access various other social features all still in conjunction while viewing the real-time video stream at the guest's device. The implementation of any live event may, more particularly, utilize a “publish/subscribe” messaging architecture, in which one or more servers act as a message broker to distribute messages to hosts and to guests based upon stored registry information and publish/subscribe logic that defines which devices (i.e., which host devices and/or which guest devices) are to receive particular classes of messages published or generated at the server(s) during progression of the live event. To participate in the live event, each host and each guest device forms a persistent connection to the server(s) (e.g., via a WebSocket), the respective connections thereby enabling each host and each guest to exchange substantially real-time information regarding the live event via the server(s) without interrupting the transmitting/displaying of the real-time video stream (e.g., without needing to refresh or reload pages). Thus, the live event provides a robust and stable social environment via which users may view and engage in offerings of one, two, three, four, ten, twenty, fifty, one hundred or more items. A live event application as described in the present disclosure can provide various GUIs and/or other functionalities that enable a guest to navigate, find, and join live events (or “live event channels”) of a particular host or relating to a particular item or item category that interests the guest (examples of such GUIs are found in U.S. Pat. No. 11,196,577).

Although the above-described systems offer significant benefits to interactive, online auction/sales platforms, still additional improvements are identified in the present disclosure. In previous implementations, a GUI displayed at guests' devices during an offering of an item included a GUI element that, when selected, (e.g., via a touchscreen tap) entered a bid or performed a purchase of the item (in an auction or in an offer for direct purchase, respectively). Although the accessibility, immediacy and ease of use of a single-tap mechanism (i.e., a tap without a sustained hold required) for bids/purchases suited the single-tap mechanism for live events, guest users may be prone to unintentionally triggering the single-tap mechanism during an offering of an item. Thus, guests might unintentionally perform a bid or purchase when the guest intends to instead interact with a different part of the same GUI, or when the guest does not intend to interact with the GUI at all. Even when an unintentional bid or purchase is resolved (e.g., cancelled) after-the-fact, the unintentional bid or purchase may nonetheless adversely affect the offering of the item by impeding or preventing other guests from obtaining the same item. A preferable alternate implementation of a bid or purchase mechanism in a GUI would offer the same accessibility, immediacy, and ease of use as the single-tap mechanism, while simultaneously protecting against unintentional triggering by the guest.

In embodiments described herein, one or more GUIs displayed at a guest device during an offering of an item include one or more interactive user interface elements that require a particular, ordered set of GUI interactions (i.e., a multi-phase interaction involving more than a single tap) to be completed to perform a bid or purchase. In an example implementation, the one or more interactive user interface elements may include a slider bar, requiring the guest user to touch a first area of a guest device touchscreen, drag in a specific direction to a second area of the touchscreen while holding the touch, and release from the touchscreen. In another example implementation, the one or more interactive user interface elements may include a button or icon that requires the user to touch a button/icon and hold the touch of the button/icon for at least a particular substantial duration of time (i.e., more than the negligible amount of time the screen is contacted during a simple tap-and-release interaction, e.g., one, one-and-a-half, or two seconds). Guarding the bid/purchase mechanism behind the particular set of GUI interactions protects the guest against unintentionally triggering a bid or purchase.

In some embodiments, the particular set of GUI interactions is the only provided mechanism for performing the bid or purchase in the live event. In other embodiments, alternate mechanisms may be provided to perform bids or purchases, but these alternate mechanisms may require still further GUI interactions that render the alternate mechanisms unlikely to be triggered accidentally (e.g., alternate mechanisms may require navigation of other interfaces, manual entry of values by the guest, etc.). Thus, the guest remains protected against unintentional bids/purchases, in any case. Although the present disclosure will describe implementations to prevent unintentional bids/purchases, it should be understood that in embodiments, the techniques herein may be applied to other interactions supported by the live events described herein.

As used in the present disclosure, “user interface element” refers to a constituent part of a user interface. That is, a user interface (e.g., a GUI) may be made up of a plurality of user interface elements (e.g., GUI elements). Each of a plurality of user interface elements making up a user interface may be individually configured to display particular information, behave in a particular manner, receive different types of user input, respond to user input in a particular manner, etc. Appearance and/or behavior of user interfaces and elements thereof may be defined and/or controlled by non-transitory instructions stored in one or more memories operatively connected to a device at which the user interfaces and elements are displayed (e.g., application instructions stored in internal memory or removable memory of a mobile computing device). Furthermore, appearance and/or behavior of user interface and elements thereof may be defined and/or controlled at least in part instructions received at the device from one or more servers with which the device communicates during display of the user interfaces and elements thereof.

### Example Computing Environment

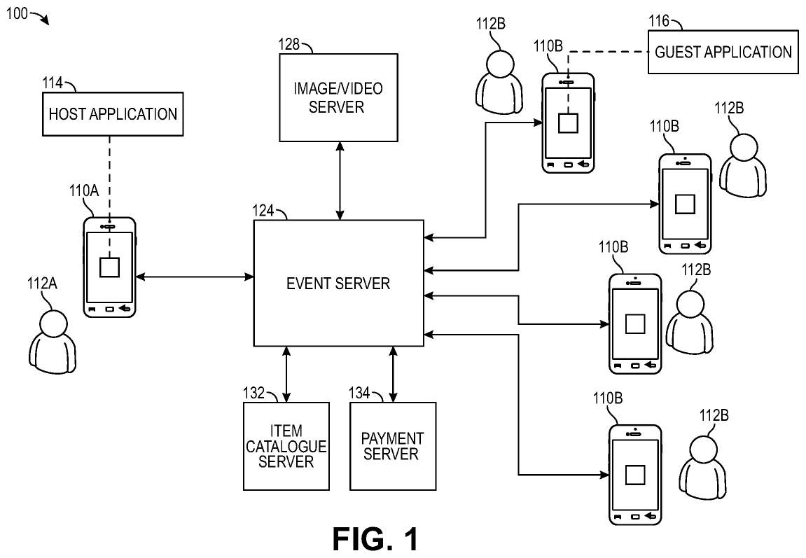

FIG. 1 depicts a block diagram of an example computing environment 100 via which techniques of the present description may be implemented. In particular, elements of the computing environment 100 may implement live events (e.g., including one or more live auctions, offers for direct purchase, and/or giveaways) in part via use of the user interfaces and user interface elements of the present disclosure. Although various components of the example computing environment 100 will be described below, it should be understood that additional, fewer, and/or alternate components may be envisioned in various embodiments, without necessarily deviating from the techniques described herein.

The computing environment includes a first mobile computing device 110a associated with a first user 112a, and a plurality of second mobile computing devices 110b associated with respective ones of a plurality of second users 112b. Mobile computing devices 110a and 110b may include, for example, smartphones, smart tablets, smart wearable devices, other suitable mobile devices, or some combination thereof. Although mobile computing devices 110a and 110b are discussed herein, it should be understood that the mobile computing devices 110a and 110b may, in some embodiments, be substituted for desktop computers and/or other non-mobile devices.

In the example environment 100, the first user 112a represents a “host” of a live event described herein, e.g., a person or entity making one or more items available for auction, direct purchase, and/or giveaway. Accordingly, the first mobile computing device 110a is generally referred to herein as a host device 110a. The second users 112b in this example represent prospective buyers/recipients (or simply “guests”) who access the live event via the systems/methods described herein to view items, bid on or purchase items, and/or perform various other actions described herein. Accordingly, the mobile computing devices 110b are referred to herein as guest devices 110b.

Each of the mobile computing devices 110a and 110b may respectively comprise one or more computer processors and one or more non-transitory computer memories storing instructions that, when executed via the one or more processors, cause the device 110a or 110b to perform the actions attributed to the device 110a or 110b in the present description. In the case of the host device 110a, the one or more non-transitory memories may store one or more software applications 114 (“host application”) including one or more sets of non-transitory computer executable instructions that, when executed via the one or more processors, cause the host device 110a to perform actions described herein. Similarly, the one or more memories of each guest device 110b may store one or more software applications 116 (“guest application”) including one or more sets of non-transitory computer executable instructions that, when executed via the one or more processors of the guest device 110b, cause the guest device 110b to perform actions described herein. Although host application 114 and guest application 116 are depicted as separate blocks in FIG. 1, it should be understood that applications 114 and 116 may represent separate aspects of the same one or more applications (e.g., a single application stored and executed both at devices 110a and 110b, in which each user 112a or 112b may alternatively operate as a host or guest using the single application). Each of the host device 110a and guest devices 110b may comprise one or more application programming interfaces (APIs) operable for example to (1) generate and display GUIs, (2) capture or otherwise obtain still images and/or videos, (3) display images, videos, item information, and/or other information described herein, (4) communicate with one or more servers (e.g., to receive real-time item information and/or communicate bids/purchases placed via the each device), and/or perform other actions described herein.

The host device 110a (and, in some instances, the guest devices 110b) may comprise one or more camera devices, which may for example capture a real-time video stream for a live event. Additionally, in some embodiments, the host device 110a (and in some instances, the guest devices 110b) includes one or more microphones and/or speaker, which may capture, transmit, and/or play audio (e.g., accompanying audio in a video stream). The one or more camera devices, microphones, and/or speakers may include integrated devices (e.g., a camera, microphone, or speaker natively included in a mobile computing device) and/or devices otherwise communicatively tethered to the host device 110a or guest device 110b (e.g., a peripheral webcam, speaker, or microphone connected wiredly or wirelessly to the mobile computing device). Additionally, each of the host device 110a and guest devices 110b may include one or more interactive I/O units (e.g., touchscreens, touchpads, keyboard, etc.) enabling navigation of GUIs, viewing of images and/or videos in the context of a real-time video stream, and/or interactive functionalities described herein.

An event server 124 (i.e., one or more servers) may facilitate communications among devices 110a and 110b, and may store various information associated with implementation of the live events as described herein. For example, the event server 124 may store and distribute information relating to items and/or item queues, and/or implement logic relating to offerings of items via auction, direct purchase, and/or giveaway. Additionally or alternatively, the event server 124 may store and/or distribute still other information such as user profile information, user device configuration information, live event metrics and analytics, etc. The event server 124 may include one or more processors and one or more non-transitory computer readable memories storing instructions that, when executed via the one or more processors, cause the event server 124 to perform the actions described herein.

The event server 124 may communicate with still additional servers to facilitate other functions described herein. For example, an image/video server 128 may facilitate operations of the event server 124 by facilitating provision of the real-time video stream from the host device 110a to the guest devices 110b (e.g., the host device 110a may provide the real-time video to the image/video server 128, which in turn may stream the image/video to the guest devices 110b without the host device 110a needing to be explicitly aware of each of the guest devices 110b). Additionally or alternatively, an item catalogue server 132 may store a listing of known items, from among which hosts 112a may explore and select one or more items to be included for auction/direct purchase in live events. Still additionally or alternatively, a payment server 134 may store and process payment information relating to hosts 112a and/or guests 112b who are to acquire items via the live events described herein. Although each of the event server 124, image/video server 128, item catalogue server 132, and payment server 134 are described in singular herein, it should be understood that each of the servers 124, 128, 132, and 134 may respectively comprise one or more server devices, with functions thereof being distributed among the one or more servers.

Arrows in FIG. 1 represent signal communications exchanged among the elements of the computing environment 100. Elements of the computing environment 100 may communicate via any suitable one or more communications networks (e.g., the Internet, a wired or wireless local area network (LAN), etc.). Elements of the computing environment 100 may communicate of via any suitable one or more communication protocols, including for example a mobile cellular communications protocol (e.g., CDMA, GSM, EV-DO, LTE, IP, etc.), one or more IEEE 802.11 protocols (e.g., Wi-Fi), Bluetooth, and/or other suitable protocols in accordance with the computing capabilities of respective elements of the computing environment 100.

Generally, each of the image/video server 128, the item catalogue server 132, and the payment servers 134 may respectively comprise one or more processors and one or more non-transitory memories storing computer executable instructions that, when executed by the one or more processors, cause the server(s) to perform actions described herein. Although arrows in FIG. 1 connect the mobile computing devices 110a and 110b to the servers 128, 132, and 134 by way of the one or more event servers 124, it should be noted that in some embodiments, the server(s) 128, 132, and/or 134 may exchange communications directly with the mobile computing devices 110a and 110b. Furthermore, although the servers 124, 128, 132, and 134 are depicted in FIG. 1 as separate elements, it should be understood that functions of the servers 124, 128, 132 and 134 may be combined in various manners, in some embodiments. For example, in some embodiments, the event server 124 is configured to also perform at least some of the functions of the image/video server 128, the item catalogue server 132, and/or the payment server 134.

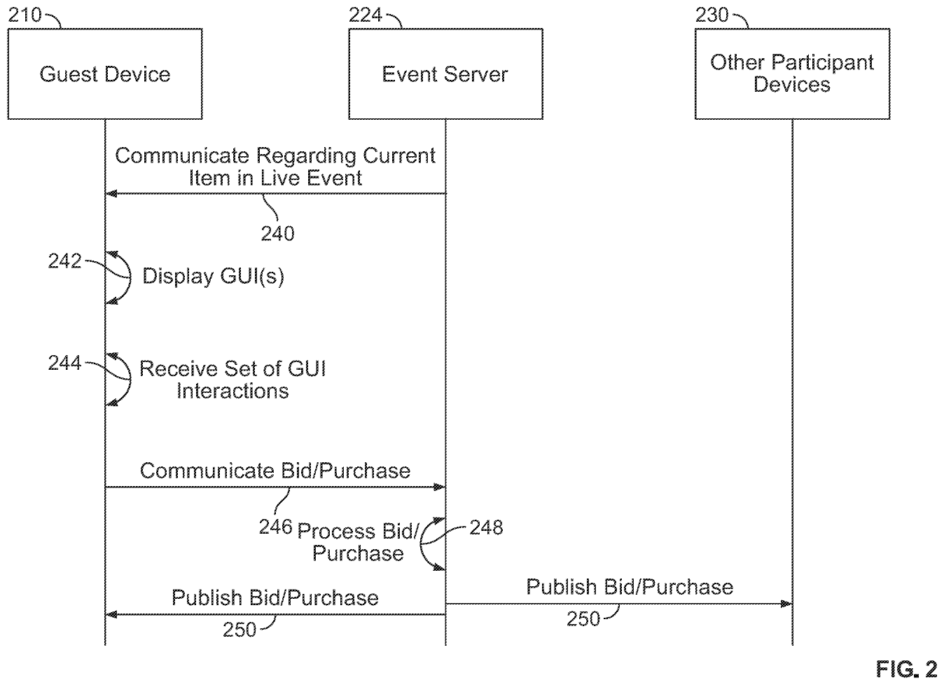

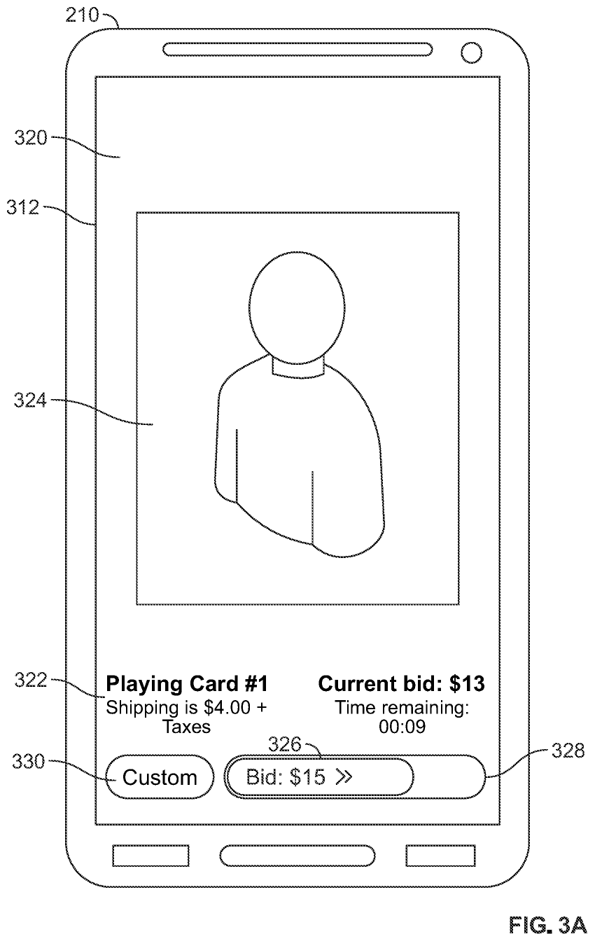

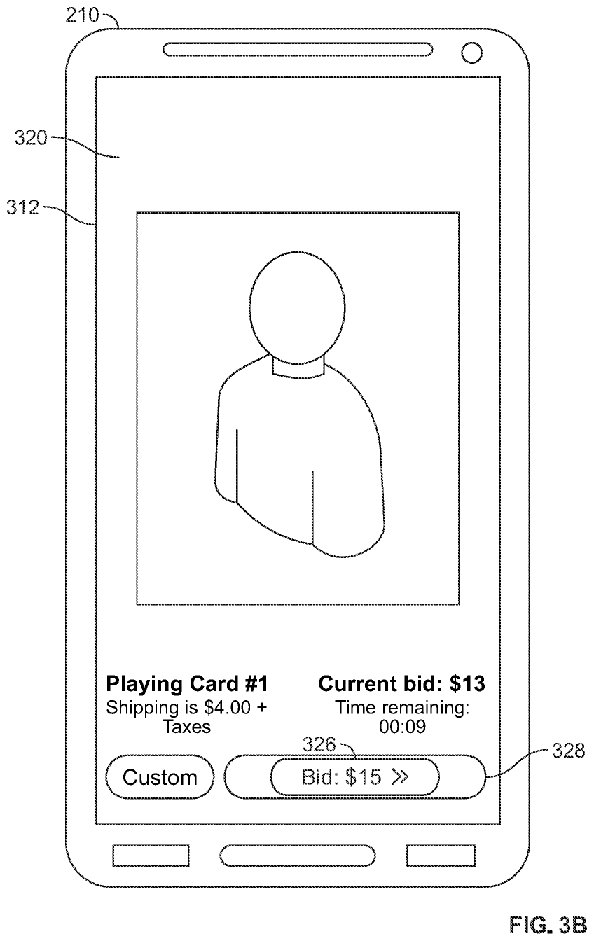

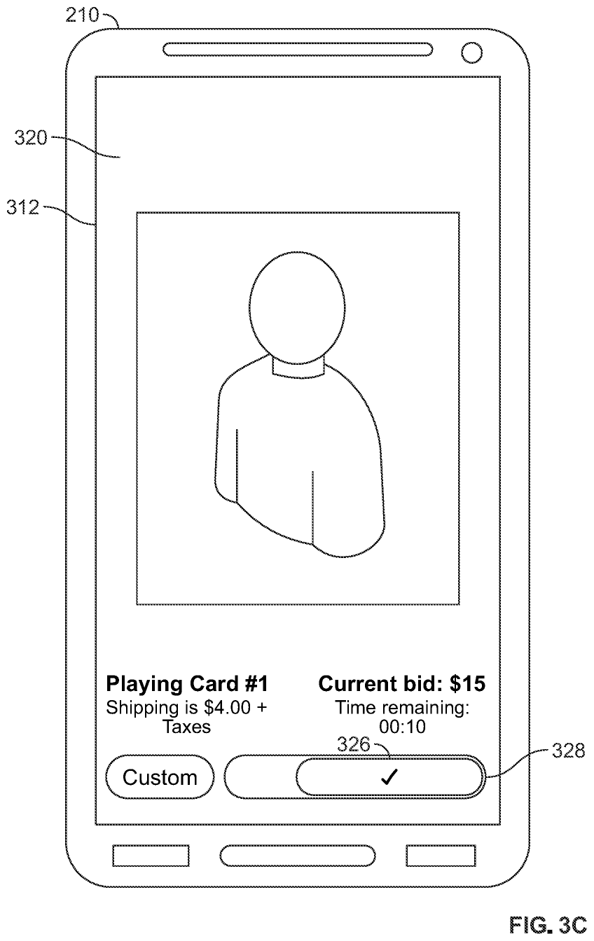

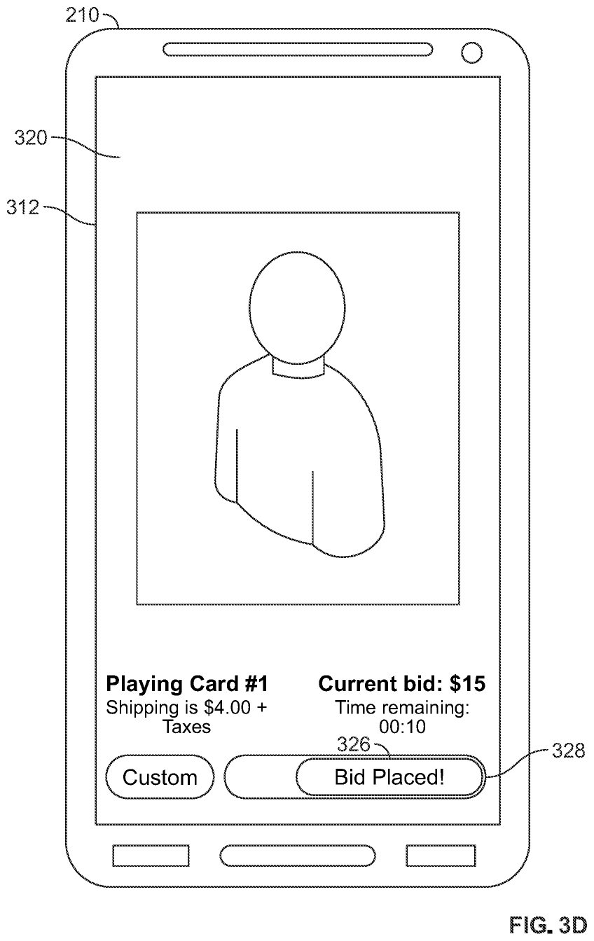

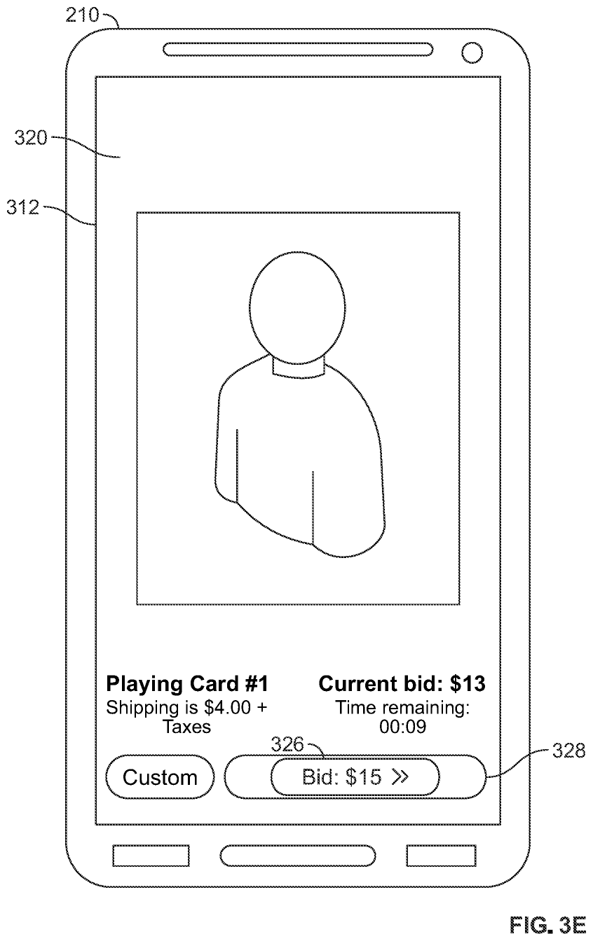

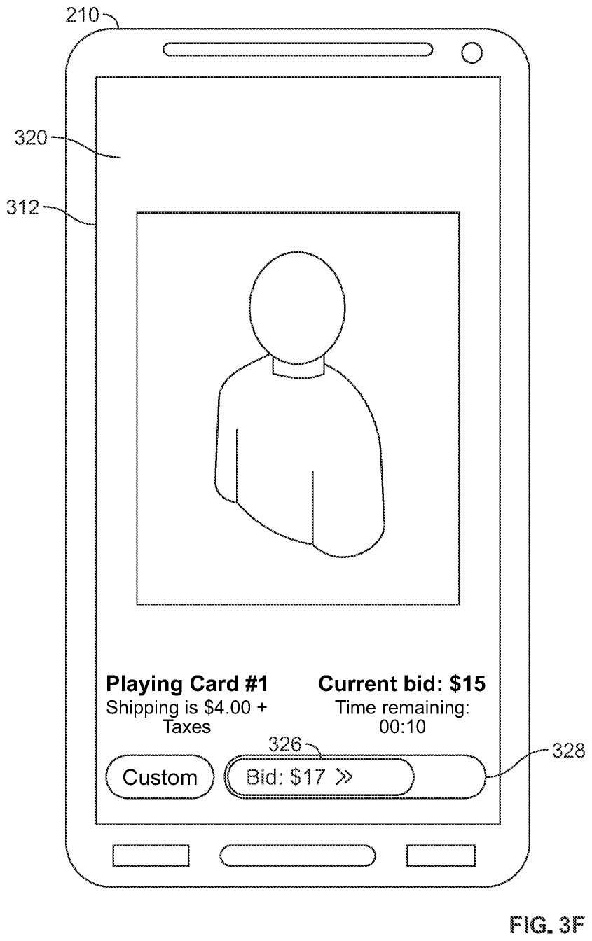

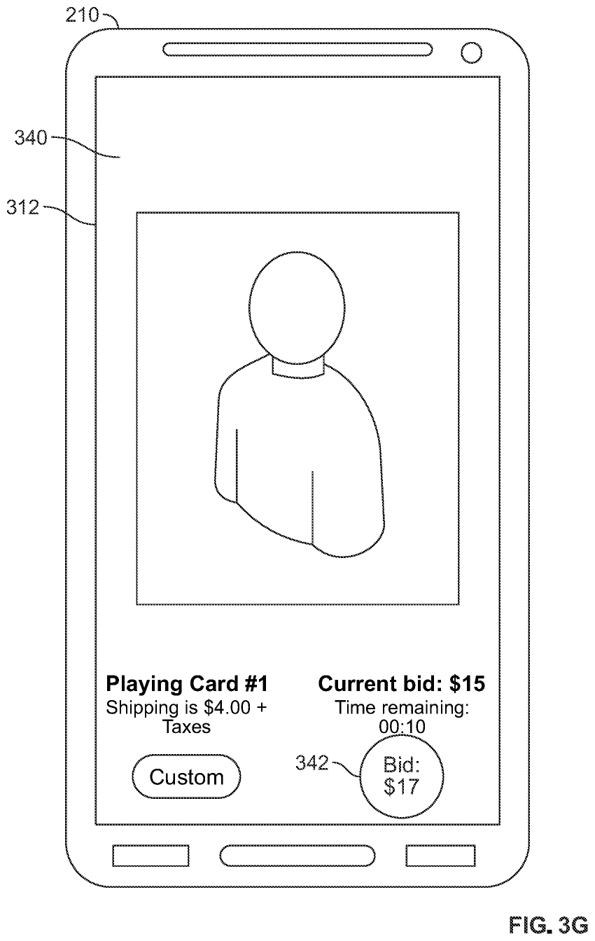

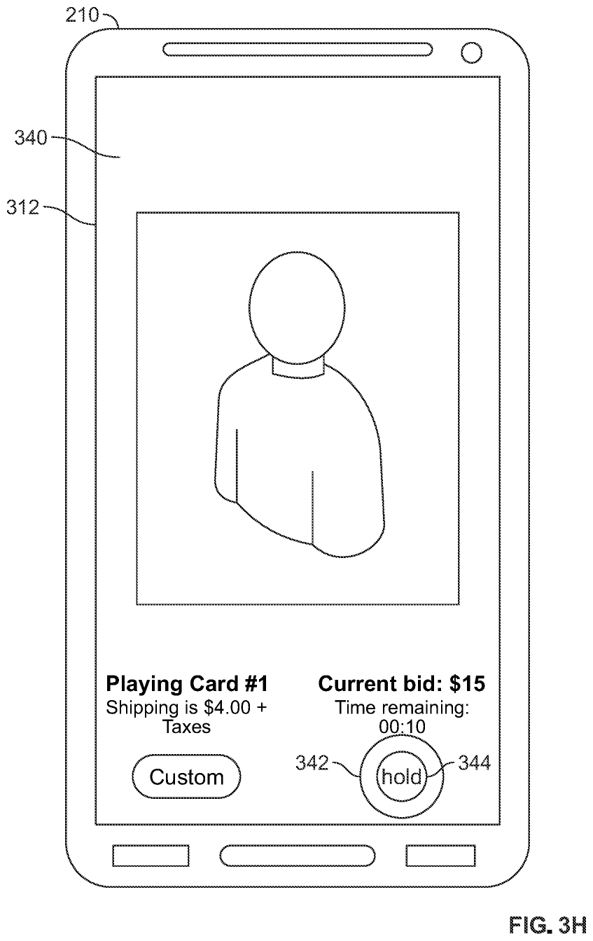

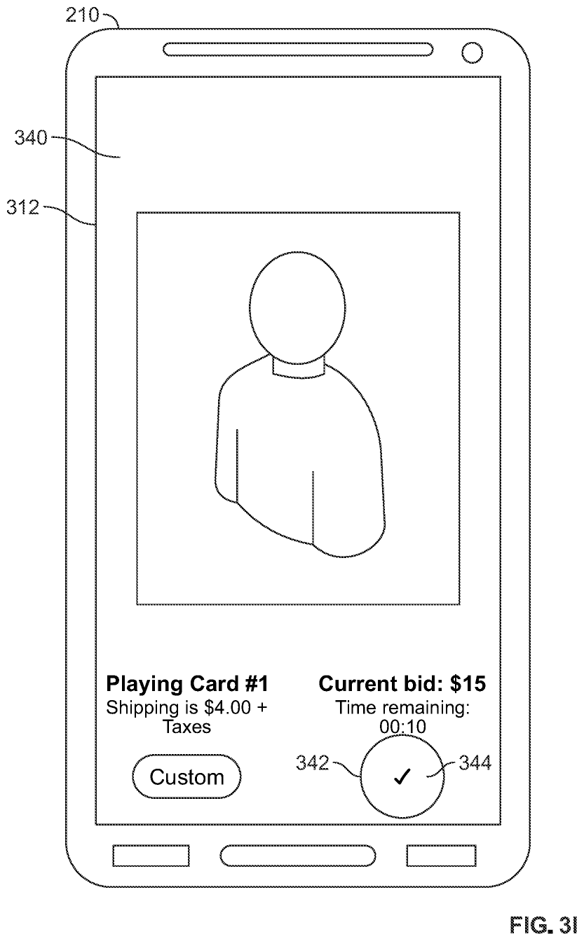

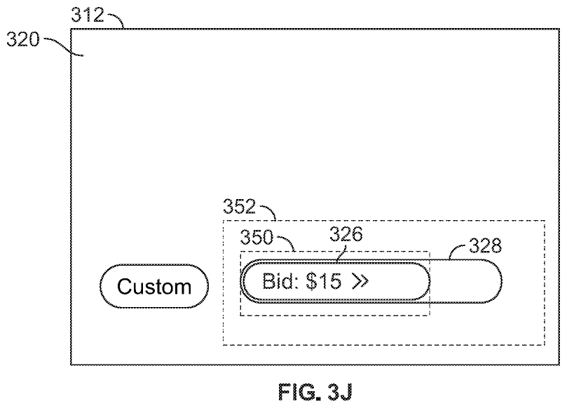

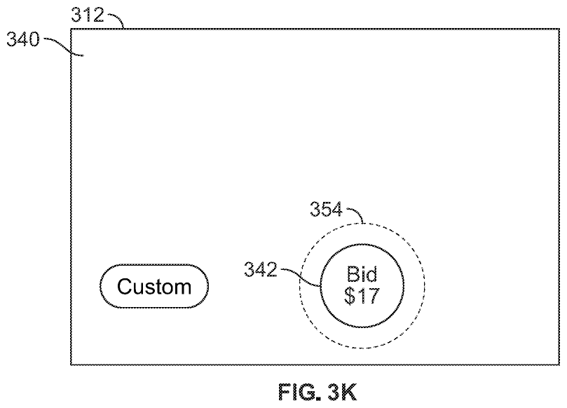

Subsequent portions of the present disclosure will describe an example signal diagram with respect to FIG. 2. The signal diagram of FIG. 2 will describe actions that may be embodied at least in part via GUIs, examples of which will be described with respect to FIGS. 3A-3K. The GUIs of FIGS. 3A-3K and actions in FIG. 2 may, in various embodiments, be implemented by suitable components of the computing environment 100 described above. Where interactive GUIs at a mobile computing device are described, interactions with the interactive GUIs may occur, for example, via touchscreen interactions, voice commands, and/or other suitable forms of user input at devices 110a and/or 110b. Described logic, communications, and functionalities may be implemented by way of the event server 124 and/or other servers of FIG. 1 which are in communication with the devices 110a and 110b.

### Example Processes and GUIs for Bids/Purchases

FIG. 2 depicts a signal diagram of an example process of using interactive GUI elements to prevent unintentional bids or purchases in live events (e.g., live stream events). Actions of the signal diagram of FIG. 2 are implemented at least in part via GUIs, examples of which will be described with respect to FIGS. 3A-3K. It should be appreciated that the GUIs of FIGS. 3A-3K are exemplary in nature, and various alterations may be envisioned, particularly with respect to ornamental characteristics of the GUIs.

The GUIs of FIGS. 3A-3K and actions in FIG. 2 may, in various embodiments, be implemented by suitable components of the computing environment 100 described in the foregoing section of this disclosure. Where interactive GUIs at a mobile computing device are described, interactions with the interactive GUIs may occur, for example, via touchscreen interactions, voice commands, and/or other suitable forms of user input at devices 110a and/or 110b.

The signal diagram of FIG. 2 involves communications among a guest device 210 participating in a live event, an event server 224, and other devices 230 participating in the live event. The guest device 210 may, for example, be a device 110b as described with respect to the computing environment 100 of FIG. 1. Similarly, the event server 224 may be an event server 124 of FIG. 1. The other participant devices 230 may include a host device (e.g., host device 110a executing the host application 114) and/or one or more other guest devices in the same live event as the guest device 210 (e.g., other guest devices 110b executing the guest application 116). Communications among the guest device 210, event server 224, and other devices 230 may be implemented, for example, via a publish/subscribe messaging architecture as described the foregoing sections of this disclosure and in U.S. Pat. No. 11,196,577. In embodiments, GUIs may execute at the guest device 210b based upon to instructions stored in a live event application as described herein (e.g., the guest device 210b may store the guest application 116 which may be configured to display the GUIs herein based at least in part upon item information and/or offering information received from the event server 224).

Referring to the signal diagram of FIG. 2, during a live event, the event server 224 transmits, to the guest device 210 (and, in embodiments, to the other devices 230), real-time information regarding an item (i.e., one or more items) currently being offered (e.g., for auction or for direct purchase) in the live event (240). The event server 224 may, for example, transmit communications to the guest device 210 indicative of an item name, item description, type of offering (e.g., auction or direct purchase), length of offering, price information (e.g., bid values or direct purchase price), social activity such as comments in the live event, etc.

Based at least in part upon the communications received from the event server 224, the guest device 210 displays one or more GUIs associated with the live event (242, e.g., based upon instructions contained in the live event application, and as described in U.S. Pat. No. 11,196,577). With reference to FIG. 3A, the one or more GUIs of action 242 may include an example GUI 320 that the guest device 210 displays via a display unit 312 (e.g., a touchscreen). The GUI 320 displays real-time information 322 associated with the item currently being offered in the live event (e.g., a name of a trading card for auction, and auction parameters including a current bid price, next minimum bid price, and time remaining in the auction). The GUI 320 displays the item information 322, and other GUI elements included in the GUI 320, over a representation of a real-time video stream 324 obtained from the host device of the host of the live event. The real-time video stream 324 may, for example, depict the host, the item currently being offered, other items queued for future offering, and/or other content relevant to the live event.

Particularly of note, the GUI 320 includes a slider element 326 contained within a slider bar element 328, particularly at a left or proximal end of the slider bar element 328. The slider 326 and slider bar 328 enable the user of the device 210 to place a bid for the current item by touching the slider 326, dragging the slider 326 across the slider bar 328 while holding the touch, and releasing the slider 326 across to a distal end of the slider bar 328 (i.e., opposite the proximal end), as will be described further with respect to subsequent figures. The amount for the bid triggered by using the elements 326 and 328 is the minimum next bid for the item given the current bid price of the item (e.g., the most recent price, plus a minimum increment for subsequent bids). In the case of direct purchases, the amount for the bid triggered by using the elements 326 and 328 is the configured direct purchase price for the current item (e.g., an amount set by the host and displayed in the GUI 320). In some embodiments, use of the slider 326 and slider bar 328 may be the only mechanism for placing the bid. In the embodiment of FIG. 3A, though, the GUI 320 further includes a “custom” icon 330, selection of which may summon an additional menu over the GUI 320 via which the user may enter a different amount to bid for the current item (e.g., an amount greater than the minimum next bid).

In an embodiment as depicted in FIG. 3A and in subsequent figures, the slider 326 may display an indication of the bid price that would be triggered by using the slider 326 and slider bar 328 to place the bid in the manner described herein. The slider bar 328 may be filled with a particular color when the user of the device 210 has not selected the slider 326, when the user has started to move the slider 326, and/or when the user has succeeded or failed to move the slider 326 across the slider bar 328 to place the bid. However, it should be understood that design choices including the colors and content (e.g., text) of the slider 326 and slider bar 328 are ornamental in nature.

Returning to the signal diagram of FIG. 2, the guest device 210 receives an ordered set of GUI interactions (244) from the user of the guest device 210 (e.g., touchscreen interactions at the display of the guest device 210). In an example implementation as depicted in FIGS. 3B-3D, the ordered set of user interactions may include a touch, drag while holding, and release of the slider 326 in the slider bar 328 at the GUI 320. FIG. 3B depicts the slider 326 held and dragged partially across the slider bar 328. Dragging the slider 326 only partially across the slider bar 328 does not trigger the bid. That is, as will be described further with respect to FIG. 3J, if the user releases the slider 326 from the position depicted in FIG. 3B, the bid does not execute. FIG. 3C depicts the GUI 320 with the slider 326 dragged fully to the distal end of the slider bar 328. The bid for the current may be triggered automatically by the slider 326 reaching the distal end of the slider bar 328, or alternatively, by the user releasing the slider 326 while the slider 326 is at the distal end of the slider bar 328. FIG. 3D depicts an alternate implementation to that of FIG. 3C in which the slider 326 when fully dragged or when released at the distal end of the slider bar 328 displays a different ornamental design choice, namely, a textual indication that the bid has been placed (i.e., instead of a checkmark or other symbol). FIG. 3E depicts an example representation of the GUI 320 when the user of the guest device 320 did not correctly complete the ordered set of GUI interactions (e.g., the user released the touch of the slider 326 before dragging to the distal end of the slider bar 328).

Returning once more to the signal diagram of FIG. 2, upon receiving the ordered set of GUI interactions from the user of the guest device 210, the guest device 210 transmits communications to the event server 224 indicative of the bid or purchase (246). The event server 224 may execute logic to process the bid or purchase, e.g., to verify the user's ability to perform the bid or purchase and to advance the state of the offering of the current item (e.g., updating a current auction price for the item, or ending an offer for direct purchase when the item has been successfully purchased). Upon processing the bid or purchase, the server 224 may publish the bid or purchase to the other devices 230 participating in the live event (250, e.g., by transmitting updated item information or offering information, by prompting the host to select a next item to be offered, etc. Based upon the updated information received from the event server 224, the GUI 320 at the client device may update automatically, as depicted in FIG. 3F (e.g., to show the next required bid price).

Other implementations of the techniques described above may be envisioned, in various embodiments. For example, FIGS. 3G-3I depict an alternate implementation where a different ordered set of GUI interactions is required to perform the bid or purchase. As depicted first in FIG. 3G, an alternate GUI 340 displayed at the guest device 210 replaces the GUI elements 326 and 328 with a button element 342. To place a bid using the button 342, the user of the guest device 210 is required to touch the button 342 and hold the touch of the button 342 for at least a predetermined duration of time (e.g., one second, one-and-a-half seconds, or two seconds). In some implementations, as depicted by FIG. 3H, when the user touches and holds the button 342, the button 342 displays a fill 344. In one implementation, the fill 344 may be displayed until the predetermined duration of time has elapsed. Alternatively, the fill 344 may be displayed and altered while the user holds the button 342 to indicate the length of time for which the user is required to hold the button (e.g., the fill 344 may grow toward the size of the button 342 until the predetermined duration of time has elapsed). In an example implementation depicted in FIG. 3I, the fill 344 grows to the size of the button 342 when the duration of time has elapsed and the bid is successful.

FIG. 3J further illustrates aspects of operation of the GUI 320 of FIGS. 3A-3F, in accordance with some embodiments. Specifically, FIG. 3J illustrates a portion of the GUI 320 on the display 312 (e.g., of the device 210). The GUI 320 in FIG. 3J includes the slider 326 and slider bar 328 as described with respect to FIGS. 3A-3F. As illustrated in FIG. 3J, the GUI 320 may implement first and/or second bounding boxes 350 and 352 that govern the operation of the slider 326 and 328. The bounding boxes 350 and 352 implemented by the GUI 320 are not actually displayed to the user of the device displaying the GUI 320, in preferred embodiments.

Generally, the GUI 320 tracks the locations and vectors of user interactions such as touch, drags, and releases on the GUI 320. The GUI 320 may detect a touch of the slider 326 when the user touches any location of the GUI 320 within the first bounding box 350. The first bounding box 350 may be sized slightly larger than the slider 326, to provide some allowance for selection of the slider 326. When the user drags across the GUI 320 after touching the slider 326 and while still holding the slider 326 (e.g., after touching within the box 350), the GUI 320 tracks a vector of the drag movement across the GUI 320, the drag movement having horizontal and vertical components. As the user drags the slider 326, the GUI 320 may update the position of the slider 326 according to the horizontal component of the movement vector until the slider bar 326 reaches the distal end (e.g., right end) of the slider bar 328 to successfully perform a bid/purchase. However, if the vertical component of the movement vector meets or exceeds a predetermined threshold, the GUI 320 may terminate the sliding of the slider 326, as the user has not dragged the slider 326 substantially enough in the horizontal direction corresponding to the slider bar 328. Additionally or alternatively, the GUI 320 may terminate the sliding of the slider 326 if, at any point before dragging the slider 326 to the distal end of the slider 328, the user drags outside of the second bounding box 352. The second bounding box 352 may be sized slightly larger than the slider bar 328 to provide allowance in the vertical and/or horizontal directions. Furthermore, still additionally or alternatively, in some embodiments, the GUI 320 may define a minimum and/or maximum duration of time or drag speed at which the drag must occur to trigger the bid/purchase. For example, if the user drags slower than the minimum required speed or the drag exceeds the maximum duration of time, the GUI 320 may not register the drag. If the user drags faster than the maximum speed or dragging the slider 326 to the distal end of the slider bar takes less than the minimum duration of time, the GUI 320 may similarly not register the drag (e.g., because an extremely fast drag may signal an unintentional interaction). In any of the above-described scenarios where the user interaction does not trigger the bid/purchase, the GUI 320 may update as described with respect to FIG. 3E to indicate that a bid/purchase has not been performed. The GUI 320 may update to reset the location of the slider 326 to the proximal end of the slider bar 328 (e.g., as in FIG. 3A).

The implementation described above, in which the movement of the slider 326 in the slider bar 328 is substantially horizontal, is just one possible implementation. In other implementations, elements of the GUI 320 may be oriented such that movement of the slider 326 in the slider bar 328 is vertical, or diagonal, and detection of failed user interactions in the GUI 320 may be adjusted accordingly. That is, the GUI 320 may terminate the dragging of the slider 326 when a component of the dragging movement vector in the direction orthogonal from the movement of the slider 326 in the slider bar 328 meets or exceeds the predetermined threshold.

FIG. 3K further illustrates aspects of operation of the GUI 340 of FIGS. 3G-3I, in accordance with some embodiments. FIG. 3K illustrates a portion of the GUI 340, including the button 342. The GUI 340 may implement a boundary 354 that governs touch interaction with the button 342 (preferably, though, the boundary 354 is not actually displayed to the user). Similarly to the GUI 320, the GUI 340 tracks locations and vectors of user interactions. The GUI 340 may detect a touch of the button 342 when the user touches within the boundary 354, or more specifically in some embodiments, within the button 342. If the user drags outside of the boundary 354 before holding the button 342 (i.e., holding the touch interaction) for the required duration of time, the GUI 340 may terminate the user interaction with the button 342 (i.e., the GUI 340 does not cause the bid/purchase to execute). Additionally or alternatively, in some embodiments, the GUI 340 may terminate the user interaction with the button 342 if the user drags instead of holding the button 342 and a vector of the drag exceeds a predetermined magnitude (i.e., length, indicating potentially unintentional improper use of the button 342). The boundary 354 may be sized slightly larger than the button 342 provide some allowance to user interaction with the button 342.

Although example GUIs have been described with respect to FIGS. 3A-3K, it should be appreciated that other implementations are possible. Further, although a mechanism for placing a bid in an auction was depicted in FIGS. 3A-3K, it should be appreciated that the same techniques may be applied to direct purchase of a current item in the live event.

It should be understood that design features depicted in FIGS. 3A-3K, including the size, placement, color, text content, and other aspects of the appearance of the user interface elements described above, are merely ornamental in nature. The functional benefits of protecting the user against unintentional bids/purchases is enabled by the functional characteristics of the above-described user interface elements (e.g., the particular configuration of the GUI elements requiring the ordered set of GUI interactions to perform the bid/purchase), rather than by any ornamental aspects of the user interface elements. Thus, any number of ornamental modifications to the user interface elements may be envisioned without deviating from the functional description of the user interface elements as described herein.

### Example Mobile Computing Device and Server

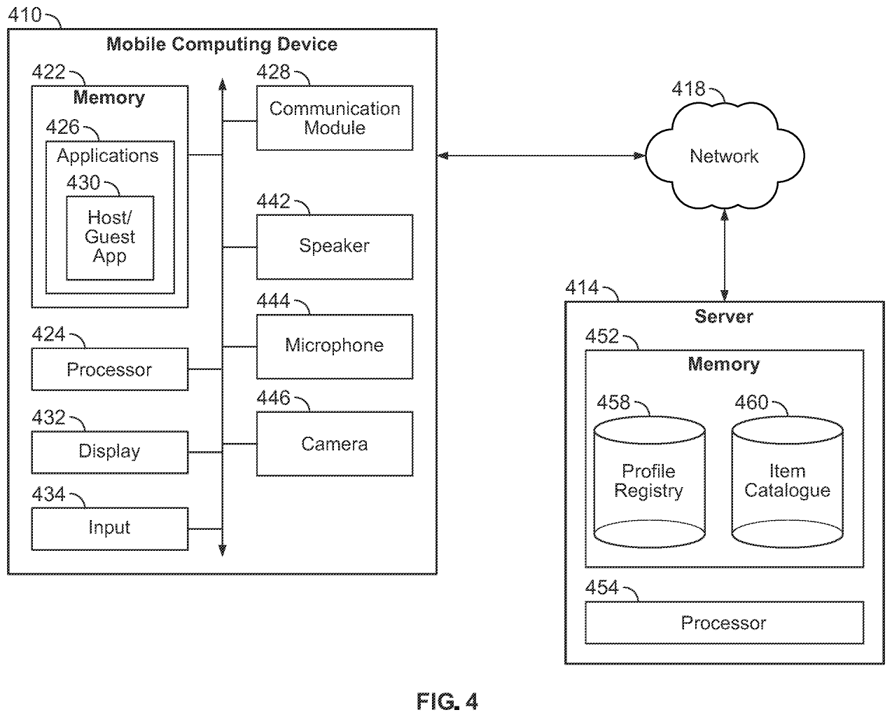

FIG. 4 depicts a block diagram of example components of a mobile computing device 410 and a server 414 communicating over a network 418, in accordance with embodiments of the systems and methods described herein. The mobile computing device 410 may correspond, for example, to any of the mobile computing devices of the present description (e.g., the host device 110a, the guest device 110b and/or 210, participant devices 230, etc.). The server 414 may correspond, for example, to the event server 124, and/or to another one or more servers of the present description. The mobile computing device and/or server 414 may include additional, fewer, or alternate components to those described in this section, in various embodiments. Additionally, in some embodiments, the mobile computing device 410 may be substituted for another computing device(s), e.g., a desktop computer or laptop computer.

The mobile computing device 410 may include a memory 422, which may include one or more non-transitory memories (e.g., ROM) and/or one or more volatile memories (e.g., RAM). In particular, non-transitory portions of the memory 422 may store non-transitory, computer executable instructions that are executable by a processor 424 (i.e., one or more processors) to cause the mobile computing device 410 to perform actions described in this detailed description. Non-transitory portions of the memory 422 may include one or more applications 426. Each respective application 426 may include one or more sets of non-transitory computer executable instructions that, when executed by the processor 424, cause the mobile computing device 410 to perform operations associated with the respective application 426 (e.g., operations involving the processor 424, a communication module 428, and/or other components of the mobile computing device 410 discussed herein). The one or more applications may include a live event application 430 (“Host/Guest App”) usable to access live events as described herein.

The mobile computing device 410 may include a display unit 432 (i.e., one or more display devices, such as a touch-enabled visual display (“touchscreen”) or other visual display). The mobile computing device may further include an input unit 434 (i.e., one or more user input devices, e.g., a touchscreen or touchpad, a keyboard, a mouse, etc.). In some embodiments, aspects of the display unit 432 and 434 are integrated (e.g., as a touchscreen with both touch input and display capability). The display unit 432 and/or the input unit 434 may be physically included within the mobile computing device 410 (e.g., a fixedly installed touchscreen), or may be operatively coupled with the mobile computing device 410 by other means (e.g., a peripheral touch pad, mouse, keyboard, etc. connected to the mobile computing device 410 by wired and/or wireless means).

The mobile computing device 410 may include a speaker 442, a microphone 444, and/or a camera 446. In some embodiments, the mobile computing device 410 may include still other sensor components, e.g., a positioning unit (e.g., GPS), an accelerometer, a gyroscope, etc. The speaker 442, microphone 444, camera 446, and/or other sensor component(s) may be physically included within the mobile computing device 410 (e.g., a natively installed speaker, microphone, or camera), and/or may be operatively coupled with the mobile computing device 410 by other means (e.g., a peripheral camera, speaker, or microphone connected to the mobile computing device 410 by wired and/or wireless means).

Collectively, the display unit 432, input unit 434, speaker 442, microphone 444, camera 446, and/or other sensing component(s) may provide one or more user interfaces of the mobile computing device 410. For example, the display unit 432 may display/present one or more GUIs which may include interactive controls that the user of the mobile computing device 410 can activate via the input device 434 to cause functionalities described herein to be performed (e.g., via a touchscreen touch or drag, a mouse click, a keyboard stroke, etc.). Additionally or alternatively, in some embodiments, similar user interfaces may be provided at least partially by the speaker 442, microphone 444, camera 446, and/or other sensing components of the mobile computing device 410 (e.g., an interactive audio interface, a gesture-based user interface, or a user interface responsive to physical movement of the mobile computing device 410). In some embodiments, a user of the live event application 430 at the mobile computing device 410 may configure device permissions defining components of the mobile computing device 410 the live event application 430 may use to provide GUIs, provide notifications, and/or perform other functionalities.

The server 414 (i.e., one or more servers, e.g., the event server 124 and/or other servers of FIG. 1) include a memory 452, which may include one or more non-transitory memories (e.g., ROM) and/or one or more volatile memories (e.g., RAM). In particular, non-transitory portions of the memory 452 may store non-transitory, computer executable instructions that are executable by a processor 454 (i.e., one or more processors) to cause the mobile computing device to perform actions described in this detailed description. Non-transitory portions of the memory 452 may include, for example, one or more applications containing non-transitory instructions for controlling logic and communications relating to live events, user profiles, device configuration information, analytics, etc. The memory 452 may further include one or more APIs configured to control communications between the server 414 and the mobile computing device 410. Still additionally or alternatively, the memory 452 may store a profile registry 458, which may store various information described herein as relating to user profiles. Still yet additionally or alternatively, the memory 452 may store an item catalogue 460, e.g., defining known items for easier inclusion in live events (e.g., as described with respect to the item catalogue server 132 of FIG. 1).

The network 418 may include any suitable one or more communications networks, e.g., the Internet, a wired or wireless local area network (LAN), etc. Communications over the network 418 may include communications according to any suitable one or more communications protocols, including for example a mobile cellular communications protocol (e.g., CDMA, GSM, EV-DO, LTE, IP, etc.), one or more IEEE 802.11 protocols (e.g., Wi-Fi), Bluetooth, and/or other suitable protocols in accordance with the computing capabilities of the mobile computing device 410 and/or the server 414.

Various additional or alternative computing elements may be envisioned, in various embodiments. In particular, it should be understood that the server 414 may communicate over the network 418 with many mobile computing devices 414, e.g., belonging to various combinations of hosts and/or guests.

### Example Computer-Implemented Method

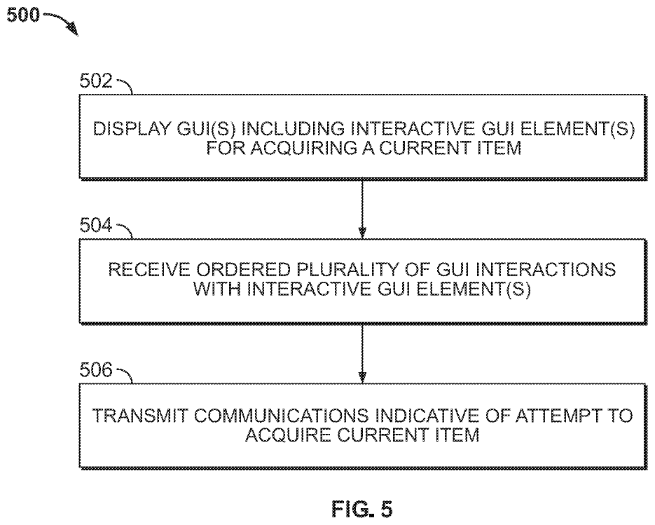

FIG. 5 depicts a block diagram of an example computer-implemented 500 associated with techniques of the foregoing portions of the present disclosure. The method 500 may be performed, for example, by a client computing device of a guest user in accordance with techniques of the present disclosure. The client computing device may, for example, be a guest device 110b, 210, and/or 410 as described in foregoing sections of the present description.

In embodiments, one or more memories of the client computing device may store non-transitory, computer executable instructions that, when executed via one or more processors of the client computing device, cause the client computing device to perform actions of the method 500. Furthermore, in some embodiments, one or more non-transitory computer readable media may be provided (e.g., a non-removable computer memory, a removable flash drive, etc.), the one or more non-transitory computer readable media storing instructions that, when executed by the client computing device, cause the client computing device to perform actions of the method 500. Actions of the method 500 may be combined and/or substituted with other actions described in the present description, in various embodiments.

The method 500 includes displaying one or more interactive GUIs at a display of a client computing device (502). The display may, for example, include a touchscreen of a mobile computing device or of another client computing device. Generally speaking, the one or more GUIs may display information associated with a current item being offered in a live event (e.g., an item being auctioned or offered for direct purchase by a host of the live event). The information may include, for example, the item name, description, bid/purchase price, and/or other information discussed in this detailed description. In some embodiments, the one or more GUIs further display a real-time video stream associated with the live event (e.g., a live stream from the host of the event, received at the client computing device via one or more servers).

In particular, though, the one or more GUIs include one or more interactive GUI elements usable at the client computing device to submit an attempt to acquire the current item (e.g., to submit a direct purchase of the current item, or to submit a bid in an auction of the current item). Submitting the attempt to acquire the current item using the one or more interactive GUI elements requires the user performing a particular ordered plurality of GUI interactions with the one or more interactive GUI elements. The ordered plurality of GUI interactions may, for example, include a touch, drag while holding the touch, and release of a slider in or around a slider bar, as described with respect to FIGS. 3A-3E (and, in some implementations, governed based upon the criteria described with respect to FIG. 3J). Alternatively, as another example, the ordered plurality of GUI interactions may include a touch, hold of the touch, and/or release of a button element, as described with respect to FIGS. 3G-3I (and, in some implementations, governed based upon the criteria described with respect to FIG. 3K). In some embodiments, performing the ordered plurality of GUI interactions is the only mechanism for submitting the attempt to acquire the current item via the one or more displayed GUIs.

The method 500 further includes receiving, via the one or more interactive GUIs from a user of the client computing device, the ordered plurality of GUI interactions with the one or more interactive GUI elements (504, e.g., receiving a touch, drag, and release interaction).

The method 500 further includes, responsive to receiving the ordered plurality of GUI interactions, transmitting, to one or more servers via one or more processors, communications indicative of the attempt to acquire the current item (506, e.g., transmitting bid or purchase information for the one or more servers to update a state of the offer of the current item). In some embodiments, the method further includes receiving further communications from the one or more servers, indicative of the updated state of the offer of the current item (e.g., a new price, time remaining, or closure of the offer for the current item). In these embodiments, the one or more GUIs at the client computing device may automatically update substantially in real-time to reflect the updated state of the offer for the current item.

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Unless a claim element is defined by reciting the word “means” and a function without the recital of any structure, it is not intended that the scope of any claim element be interpreted based upon the application of 35 U.S.C. § 112(f). The systems and methods described herein are directed to an improvement to computer functionality, and improve the functioning of conventional computers.

Throughout this specification, plural instances may implement components, operations, or structures described as a single instance. Although individual operations of one or more methods are depicted and described as separate operations, one or more of the individual operations may be performed concurrently, and nothing requires that the operations be performed in the order depicted. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment. In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Throughout the present disclosure, embodiments are described in which various elements are optional—present in some, but not all, embodiments of the system. Where such elements are depicted in the accompanying figures and, specifically, in figures depicting block diagrams, the optional elements are generally depicted in dotted lines to denote their optional nature.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for generating dynamic user experience applications through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims. The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited, and modifications may be made without departing from the invention. The scope of the invention is defined by the appended claims, and all devices that come within the meaning of the claims, either literally or by equivalence, are intended to be embraced therein. It is therefore intended that the foregoing detailed description be regarded as illustrative rather than limiting, and that it be understood that it is the following claims, including all equivalents, that are intended to define the spirit and scope of this invention.

By way of example, and not limitation, the present disclosure contemplates at least the following aspects:

1. A computer-implemented method comprising: displaying, via a display unit of a client computing device, one or more interactive graphical user interfaces (GUIs) displaying information associated with a current item offered in a live event, the one or more interactive GUIs comprising one or more interactive GUI elements usable at the client computing device to submit an attempt to acquire the current item, wherein submitting the attempt to acquire the current item using the one or more interactive GUI elements requires performing a particular ordered plurality of GUI interactions with the one or more interactive GUI elements.

2. The computer-implemented method of aspect 1, further comprising: receiving, via the one or more interactive GUIs via input from a user associated with the client computing device, the ordered plurality of GUI interactions with the one or more interactive GUI elements; and responsive to receiving the ordered plurality of GUI interactions, transmitting, to one or more servers via one or more processors, communications indicative of the attempt to acquire the current item.

3. The computer-implemented method of aspect 2, wherein the one or more interactive GUI elements comprise a slider element and a slider bar element, and wherein performing the particular ordered plurality of GUI interactions comprises (1) touching the slider element, and (2) dragging the slider element across an area of the display associated with the slider bar element while holding the touch of the slider element.

4. The computer-implemented method of aspect 3, wherein receiving the ordered plurality of GUI interactions via the one or more interactive GUIs comprises: tracking a movement vector of the dragging of the slider element; and determining that the ordered plurality of GUI interactions have been successfully performed based at least in part upon determining that (1) the movement vector does not exit a bounding box associated with the slider bar element, and/or (2) a component of the movement vector in a first direction orthogonal to a second direction of movement of the slider with respect to the slider bar is less than or equal to a predetermined threshold.

5. The computer-implemented method of aspect 2, wherein the one or more interactive GUI elements comprise a button element, and wherein the particular ordered plurality of GUI interactions comprises touching the button and holding the touch of the button for at least a predetermined duration of time.

6. The computer-implemented method of aspect 5, wherein receiving the ordered plurality of GUI interactions via the one or more interactive GUIs comprises: tracking a movement vector of a dragging operation during the holding of the button; and determining that the ordered plurality of GUI interactions have been successfully performed based at least in part upon determining that (1) a magnitude of the movement vector is less than or equal to a predetermined threshold, and/or (2) the movement vector does not exit a boundary associated with the button.

7. The computer-implemented method of any one of aspects 1-6, wherein displaying the one or more interactive GUIs comprises displaying a real-time video stream associated with the live event, the real-time video stream being received at the client computing device via the one or more servers.

8. The computer-implemented method of any one of aspects 1-7, wherein the current item is an item offered for auction via the live event, and wherein the attempt to acquire the current item is an auction bid for the current item.

9. The computer-implemented method of any one of aspects 1-7, wherein the current item is an item offered for direct purchase via the live event, and wherein the attempt to acquire the current item is a purchase of the item offered for direct purchase.

10. The computer-implemented method of aspect 2, further comprising, subsequent to transmitting the first communications indicative of the attempt to acquire the current item: receiving, via the one or more processors from the one or more servers, further communications indicative of updated real-time information associated with the current item being offered in the live event; and responsive to receiving the further communications, automatically updating the one or more interactive GUIs to indicate the updated real-time information.

11. The computer-implemented method of any one of aspects 1-10, wherein the display unit comprises a touchscreen of a mobile computing device.

12. The computer-implemented method of aspect 1, further comprising: receiving, via the one or more interactive GUIs via input from a user associated with the client computing device, one or more GUI interactions with the one or more interactive GUI elements; and determining, via the one or more processors, whether the received one or more GUI interactions include the required ordered plurality of GUI interactions.

13. The computer-implemented method of aspect 12, wherein determining whether the received one or more GUI interactions include the required ordered plurality of GUI interactions comprise determining that the received one or more GUI interactions include the required ordered plurality of GUI interactions, and the method further comprising, responsive to determining that the received one or more GUI interactions include the required ordered plurality of GUI interactions, transmitting, to one or more servers via one or more processors, communications indicative of the attempt to acquire the current item.

14. The computer-implemented method of aspect 12, wherein determining whether the received one or more GUI interactions include the required ordered plurality of GUI interactions comprise determining that the received one or more GUI interactions do not include the required ordered plurality of GUI interactions, and the method further comprising, responsive to determining that the received one or more GUI interactions do not include the required ordered plurality of GUI interactions, displaying, via the one or more interactive GUIs, an indication that the attempt to acquire the current item failed.

15. The computer-implemented method of any one of aspects 1-14, in combination with any other suitable one of aspects 1-14.

16. One or more non-transitory computer readable media storing instructions that, when executed via one or more processors of a client computing device, cause the client computing device to: display, via a display unit of the client computing device, one or more interactive GUIs displaying information associated with a current item offered in a live event, the one or more interactive GUIs comprising one or more interactive GUI elements usable at the client computing device to submit an attempt to acquire the current item, wherein submitting the attempt to acquire the current item using the one or more interactive GUI elements requires performing a particular ordered plurality of GUI interactions with the one or more interactive GUI elements;

17. The one or more non-transitory computer readable media of aspect 16, wherein the instructions, when executed via the one or more processors, further cause the client computing device to: receive, via the one or more interactive GUIs via input from a user associated with the client computing device, the ordered plurality of GUI interactions with the one or more interactive GUI elements; and responsive to receiving the ordered plurality of GUI interactions, transmit, to one or more servers, communications indicative of the attempt to acquire the current item.

18. The one or more non-transitory computer readable media of aspect 17, wherein the one or more interactive GUI elements comprise a slider element and a slider bar element, and wherein performing the particular ordered plurality of GUI interactions comprises (1) touching the slider element, and (2) dragging the slider element across an area of the display associated with the slider bar element while holding the touch of the slider element.

19. The one or more non-transitory computer readable media of aspect 18, wherein the instructions to receive the ordered plurality of GUI interactions via the one or more interactive GUIs include instructions to: track a movement vector of the dragging of the slider element; and determine that the ordered plurality of GUI interactions have been successfully performed based at least in part upon determining that (1) the movement vector does not exit a bounding box associated with the slider bar element, and/or (2) a component of the movement vector in a first direction orthogonal to a second direction of movement of the slider with respect to the slider bar is less than or equal to a predetermined threshold.

20. The one or more non-transitory computer readable media of aspect 17, wherein the one or more interactive GUI elements comprise a button element, and wherein the particular ordered plurality of GUI interactions comprises touching the button and holding the touch of the button for at least a predetermined duration of time.

21. The one or more non-transitory computer readable media of aspect 20, wherein the instructions to receive the ordered plurality of GUI interactions via the one or more interactive GUIs comprise instructions to: track a movement vector of a dragging operation during the holding of the button; and determine that the ordered plurality of GUI interactions have been successfully performed based at least in part upon determining that (1) a magnitude of the movement vector is less than or equal to a predetermined threshold, and/or (2) the movement vector does not exit a boundary associated with the button.

22. The one or more non-transitory computer readable media of any one of aspects 16-21, wherein the instructions to display the one or more interactive GUIs comprise instructions to display a real-time video stream associated with the live event, the real-time video stream being received at the client computing device via the one or more servers.

23. The one or more non-transitory computer readable media of any one of aspects 16-22, wherein the current item is an item offered for auction via the live event, and wherein the attempt to acquire the current item is an auction bid for the current item.

24. The one or more non-transitory computer readable media of any one of aspects 16-22, wherein the current item is an item offered for direct purchase via the live event, and wherein the attempt to acquire the current item is a purchase of the item offered for direct purchase.

25. The one or more non-transitory computer readable media of aspect 17, wherein the instructions, when executed by the one or more processors, further cause the client computing device to, subsequent to transmitting the first communications indicative of the attempt to acquire the current item: receive, via the one or more servers, further communications indicative of updated real-time information associated with the current item being offered in the live event; and responsive to receiving the further communications, automatically update the one or more interactive GUIs to indicate the updated real-time information.

26. The one or more non-transitory computer readable media of any one of aspects 16-25, wherein the client computing device is a mobile computing device, and wherein the display unit comprises a touchscreen of the mobile computing device.

27. The one or more non-transitory computer readable media of aspect 16, wherein the instructions, when executed via the one or more processors, further cause the client computing device to: receive, via the one or more interactive GUIs via input from a user associated with the client computing device, one or more GUI interactions with the one or more interactive GUI elements; and determine whether the received one or more GUI interactions include the required ordered plurality of GUI interactions.

28. The one or more non-transitory computer readable media of aspect 27, wherein the instructions to determine whether the received one or more GUI interactions include the required ordered plurality of GUI interactions comprise instructions to determine that the received one or more GUI interactions include the required ordered plurality of GUI interactions, and wherein the instructions, when executed via the one or more processors, further cause the client computing device to, responsive to determining that the received one or more GUI interactions include the required ordered plurality of GUI interactions, transmit, to one or more servers, communications indicative of the attempt to acquire the current item.

29. The one or more non-transitory computer readable media of aspect 27, wherein the instructions to determine whether the received one or more GUI interactions include the required ordered plurality of GUI interactions comprise instructions to determine that the received one or more GUI interactions do not include the required ordered plurality of GUI interactions, and wherein the instructions, when executed via the one or more processors, further cause the client computing device to, responsive to determining that the received one or more GUI interactions do not include the required ordered plurality of GUI interactions, display, via the one or more interactive GUIs, an indication that the attempt to acquire the current item failed.

30. The one or more non-transitory computer readable media of any one of aspects 16-29, in combination with any other suitable one of aspects 16-29.

31. The one or more non-transitory computer readable media of any one of aspects 16-29, configured to perform the method of any suitable one of aspects 1-15.

32. A client computing device comprising: one or more processors; a display unit; and one or more computer memories storing non-transitory instructions that, when executed via the one or more processors, cause the client computing device to: display, via the display unit, one or more interactive GUIs displaying information associated with a current item offered in a live event, the one or more interactive GUIs comprising one or more interactive GUI elements usable at the client computing device to submit an attempt to acquire the current item, wherein submitting the attempt to acquire the current item using the one or more interactive GUI elements requires performing a particular ordered plurality of GUI interactions with the one or more interactive GUI elements.

33. The client computing device of aspect 32, wherein the instructions, when executed by the one or more processors, further cause the client computing device to: receive, via the one or more interactive GUIs via input from a user associated with the client computing device, the ordered plurality of GUI interactions with the one or more interactive GUI elements; and responsive to receiving the ordered plurality of GUI interactions, transmit, to one or more servers, communications indicative of the attempt to acquire the current item.

34. The client computing device of aspect 33, wherein the one or more interactive GUI elements comprise a slider element and a slider bar element, and wherein performing the particular ordered plurality of GUI interactions comprises (1) touching the slider element, and (2) dragging the slider element across an area of the display associated with the slider bar element while holding the touch of the slider element.

35. The client computing device of aspect 34, wherein the instructions to receive the ordered plurality of GUI interactions via the one or more interactive GUIs comprise instructions to: track a movement vector of the dragging of the slider element; and determine that the ordered plurality of GUI interactions have been successfully performed based at least in part upon determining that (1) the movement vector does not exit a bounding box associated with the slider bar element, and/or (2) a component of the movement vector in a first direction orthogonal to a second direction of movement of the slider with respect to the slider bar is less than or equal to a predetermined threshold.

36. The client computing device of aspect 33, wherein the one or more interactive GUI elements comprise a button element, and wherein the particular ordered plurality of GUI interactions comprises touching the button and holding the touch of the button for at least a predetermined duration of time.

37. The client computing device of aspect 36, wherein the instructions to receive the ordered plurality of GUI interactions via the one or more interactive GUIs include instructions to: track a movement vector of a dragging operation during the holding of the button; and determine that the ordered plurality of GUI interactions have been successfully performed based at least in part upon determining that (1) a magnitude of the movement vector is less than or equal to a predetermined threshold, and/or (2) the movement vector does not exit a boundary associated with the button.

38. The client computing device of any one of aspects 32-37, wherein the instructions to display the one or more interactive GUIs comprise instructions to display a real-time video stream associated with the live event, the real-time video stream being received at the client computing device via the one or more servers.

39. The client computing device of any one of aspects 32-38, wherein the current item is an item offered for auction via the live event, and wherein the attempt to acquire the current item is an auction bid for the current item.

40. The client computing device of any one of aspects 32-38, wherein the current item is an item offered for direct purchase via the live event, and wherein the attempt to acquire the current item is a purchase of the item offered for direct purchase.

41. The client computing device of aspect 33, wherein the instructions, when executed by the one or more processors, further cause the client computing device to, subsequent to transmitting the first communications indicative of the attempt to acquire the current item: receive, via the one or more servers, further communications indicative of updated real-time information associated with the current item being offered in the live event; and responsive to receiving the further communications, automatically update the one or more interactive GUIs to indicate the updated real-time information.

42. The client computing device of any one of aspects 32-41, wherein the client computing device is a mobile computing device, and wherein the display is a touchscreen of the mobile computing device.

43. The client computing device of aspect 32, wherein the instructions, when executed via the one or more processors, further cause the client computing device to: receive, via the one or more interactive GUIs via input from a user associated with the client computing device, one or more GUI interactions with the one or more interactive GUI elements; and determine whether the received one or more GUI interactions include the required ordered plurality of GUI interactions.

44. The client computing device of aspect 43, wherein the instructions to determine whether the received one or more GUI interactions include the required ordered plurality of GUI interactions comprise instructions to determine that the received one or more GUI interactions include the required ordered plurality of GUI interactions, and wherein the instructions, when executed via the one or more processors, further cause the client computing device to, responsive to determining that the received one or more GUI interactions include the required ordered plurality of GUI interactions, transmit, to one or more servers, communications indicative of the attempt to acquire the current item.

45. The client computing device of aspect 43, wherein the instructions to determine whether the received one or more GUI interactions include the required ordered plurality of GUI interactions comprise instructions to determine that the received one or more GUI interactions do not include the required ordered plurality of GUI interactions, and wherein the instructions, when executed via the one or more processors, further cause the client computing device to, responsive to determining that the received one or more GUI interactions do not include the required ordered plurality of GUI interactions, display, via the one or more interactive GUIs, an indication that the attempt to acquire the current item failed.

46. The client computing device of any one of aspects 32-45, in combination with any other suitable one of aspects 32-45.

47. The client computing device of any one of aspects 32-45, comprising the one or more non-transitory computer readable media of any suitable one of aspects 16-31.

48. The client computing device of any one of aspects 32-45, configured to perform the computer-implemented method of any suitable one of aspects 1-15.

49. Any one of aspects 1-48 in combination with any other suitable one of aspects 1-48.

What is claimed is:

1. A computer-implemented method comprising:
displaying, via a display unit of a client computing device, one or more interactive graphical user interfaces (GUIs) displaying information associated with a current item offered in a live event,
the one or more interactive GUIs comprising one or more interactive GUI elements usable at the client computing device to submit an attempt to acquire the current item, wherein submitting the attempt to acquire the current item using the one or more interactive GUI elements requires performing a particular ordered plurality of GUI interactions with the one or more interactive GUI elements;
receiving, via the one or more interactive GUIs via input from a user associated with the client computing device, the ordered plurality of GUI interactions with the one or more interactive GUI elements; and
responsive to receiving the ordered plurality of GUI interactions, transmitting, to one or more servers via one or more processors, communications indicative of the attempt to acquire the current item.

2. The computer-implemented method of claim 1, wherein the one or more interactive GUI elements comprise a slider element and a slider bar element, and wherein performing the particular ordered plurality of GUI interactions comprises (1) touching the slider element, and (2) dragging the slider element across an area of the display associated with the slider bar element while holding the touch of the slider element.

3. The computer-implemented of claim 2, wherein receiving the ordered plurality of GUI interactions via the one or more interactive GUIs comprises:
tracking a movement vector of the dragging of the slider element; and
determining that the ordered plurality of GUI interactions have been successfully performed based at least in part upon determining that (1) the movement vector does not exit a bounding box associated with the slider bar element, and/or (2) a component of the movement vector in a first direction orthogonal to a second direction of movement of the slider with respect to the slider bar is less than or equal to a predetermined threshold.

4. The computer-implemented method of claim 1, wherein the one or more interactive GUI elements comprise a button element, and wherein the particular ordered plurality of GUI interactions comprises touching the button and holding the touch of the button for at least a predetermined duration of time.

5. The computer-implemented method of claim 4, wherein receiving the ordered plurality of GUI interactions via the one or more interactive GUIs comprises:
tracking a movement vector of a dragging operation during the holding of the button; and
determining that the ordered plurality of GUI interactions have been successfully performed based at least in part upon determining that (1) a magnitude of the movement vector is less than or equal to a predetermined threshold, and/or (2) the movement vector does not exit a boundary associated with the button.

6. The computer-implemented method of claim 1, wherein displaying the one or more interactive GUIs comprises displaying a real-time video stream associated with the live event, the real-time video stream being received at the client computing device via the one or more servers.

7. The computer-implemented method of claim 1, wherein the current item is an item offered for auction via the live event, and wherein the attempt to acquire the current item is an auction bid for the current item.

8. The computer-implemented method of claim 1, wherein the current item is an item offered for direct purchase via the live event, and wherein the attempt to acquire the current item is a purchase of the item offered for direct purchase.

9. The computer-implemented method of claim 1, further comprising, subsequent to transmitting the first communications indicative of the attempt to acquire the current item:
receiving, via the one or more processors from the one or more servers, further communications indicative of updated real-time information associated with the current item being offered in the live event; and
responsive to receiving the further communications, automatically updating the one or more interactive GUIs to indicate the updated real-time information.

10. The computer-implemented method of claim 1, wherein the display unit comprises a touchscreen of a mobile computing device.

11. One or more non-transitory computer readable media storing instructions that, when executed via one or more processors of a client computing device, cause the client computing device to:
display, via a display unit of the client computing device, one or more interactive GUIs displaying information associated with a current item offered in a live event,
the one or more interactive GUIs comprising one or more interactive GUI elements usable at the client computing device to submit an attempt to acquire the current item, wherein submitting the attempt to acquire the current item using the one or more interactive GUI elements requires performing a particular ordered plurality of GUI interactions with the one or more interactive GUI elements;
receive, via the one or more interactive GUIs via input from a user associated with the client computing device, the ordered plurality of GUI interactions with the one or more interactive GUI elements; and
responsive to receiving the ordered plurality of GUI interactions, transmit, to one or more servers, communications indicative of the attempt to acquire the current item.

12. The one or more non-transitory computer readable media of claim 11, wherein the one or more interactive GUI elements comprise a slider element and a slider bar element, and wherein performing the particular ordered plurality of GUI interactions comprises (1) touching the slider element, and (2) dragging the slider element across an area of the display associated with the slider bar element while holding the touch of the slider element.

13. The one or more non-transitory computer readable media of claim 12, wherein the instructions to receive the ordered plurality of GUI interactions via the one or more interactive GUIs comprise instructions to:
track a movement vector of the dragging of the slider element; and
determine that the ordered plurality of GUI interactions have been successfully performed based at least in part upon determining that (1) the movement vector does not exit a bounding box associated with the slider bar element, and/or (2) a component of the movement vector in a first direction orthogonal to a second direction of movement of the slider with respect to the slider bar is less than or equal to a predetermined threshold.

14. The one or more non-transitory computer readable media of claim 11, wherein the one or more interactive GUI elements comprise a button element, and wherein the particular ordered plurality of GUI interactions comprises touching the button and holding the touch of the button for at least a predetermined duration of time.

15. The one or more non-transitory computer readable media of claim 14, wherein the instructions to receive the ordered plurality of GUI interactions via the one or more interactive GUIs comprise instructions to:
track a movement vector of a dragging operation during the holding of the button; and
determine that the ordered plurality of GUI interactions have been successfully performed based at least in part upon determining that (1) a magnitude of the movement vector is less than or equal to a predetermined threshold, and/or (2) the movement vector does not exit a boundary associated with the button.

16. The one or more non-transitory computer readable media of claim 11, wherein the instructions to display the one or more interactive GUIs comprise instructions to display a real-time video stream associated with the live event, the real-time video stream being received at the client computing device via the one or more servers.

17. The one or more non-transitory computer readable media of claim 11, wherein the current item is an item offered for auction via the live event, and wherein the attempt to acquire the current item is an auction bid for the current item.

18. The one or more non-transitory computer readable media of claim 11, wherein the current item is an item offered for direct purchase via the live event, and wherein the attempt to acquire the current item is a purchase of the item offered for direct purchase.

19. The one or more non-transitory computer readable media of claim 11, wherein the instructions, when executed by the one or more processors, further cause the client computing device to, subsequent to transmitting the first communications indicative of the attempt to acquire the current item:
receive, via the one or more servers, further communications indicative of updated real-time information associated with the current item being offered in the live event; and
responsive to receiving the further communications, automatically update the one or more interactive GUIs to indicate the updated real-time information.

20. The one or more non-transitory computer readable media of claim 11, wherein the client computing device is a mobile computing device, and wherein the display unit comprises a touchscreen of the mobile computing device.

21. A client computing device comprising:
one or more processors;
a display unit; and
one or more computer memories storing non-transitory instructions that, when executed via the one or more processors, cause the client computing device to:
display, via the display unit, one or more interactive GUIs displaying information associated with a current item offered in a live event,
the one or more interactive GUIs comprising one or more interactive GUI elements usable at the client computing device to submit an attempt to acquire the current item, wherein submitting the attempt to acquire the current item using the one or more interactive GUI elements requires performing a particular ordered plurality of GUI interactions with the one or more interactive GUI elements;
receive, via the one or more interactive GUIs via input from a user associated with the client computing device, the ordered plurality of GUI interactions with the one or more interactive GUI elements; and
responsive to receiving the ordered plurality of GUI interactions, transmit, to one or more servers, communications indicative of the attempt to acquire the current item.

22. The client computing device of claim 21, wherein the one or more interactive GUI elements comprise a slider element and a slider bar element, and wherein performing the particular ordered plurality of GUI interactions comprises (1) touching the slider element, and (2) dragging the slider element across an area of the display associated with the slider bar element while holding the touch of the slider element.

23. The client computing device of claim 22, wherein the instructions to receive the ordered plurality of GUI interactions via the one or more interactive GUIs comprise instructions to:
track a movement vector of the dragging of the slider element; and
determine that the ordered plurality of GUI interactions have been successfully performed based at least in part upon determining that (1) the movement vector does not exit a bounding box associated with the slider bar element, and/or (2) a component of the movement vector in a first direction orthogonal to a second direction of movement of the slider with respect to the slider bar is less than or equal to a predetermined threshold.

24. The client computing device of claim 21, wherein the one or more interactive GUI elements comprise a button element, and wherein the particular ordered plurality of GUI interactions comprises touching the button and holding the touch of the button for at least a predetermined duration of time.

25. The client computing device of claim 24, wherein the instructions to receive the ordered plurality of GUI interactions via the one or more interactive GUIs comprise instructions to:
track a movement vector of a dragging operation during the holding of the button; and
determine that the ordered plurality of GUI interactions have been successfully performed based at least in part upon determining that (1) a magnitude of the movement vector is less than or equal to a predetermined threshold, and/or (2) the movement vector does not exit a boundary associated with the button.

26. The client computing device of claim 21, wherein the instructions to display the one or more interactive GUIs comprise instructions to display a real-time video stream associated with the live event, the real-time video stream being received at the client computing device via the one or more servers.

27. The client computing device of claim 21, wherein the current item is an item offered for auction via the live event, and wherein the attempt to acquire the current item is an auction bid for the current item.

28. The client computing device of claim 21, wherein the current item is an item offered for direct purchase via the live event, and wherein the attempt to acquire the current item is a purchase of the item offered for direct purchase.

29. The client computing device of claim 21, wherein the instructions, when executed by the one or more processors, further cause the client computing device to, subsequent to transmitting the first communications indicative of the attempt to acquire the current item:
receive, via the one or more servers, further communications indicative of updated real-time information associated with the current item being offered in the live event; and
responsive to receiving the further communications, automatically update the one or more interactive GUIs to indicate the updated real-time information.

30. The client computing device of claim 21, wherein the client computing device is a mobile computing device, and wherein the display is a touchscreen of the mobile computing device.
